(19) United States
(12) Patent Application Publication
(10) Pub. No.: US 2021/0092348 A1
(43) Pub. Date: Mar. 25, 2021

(54) GENERATION APPARATUS, RECONSTRUCTION APPARATUS, GENERATION METHOD, CONTROL PROGRAM, AND RECORDING MEDIUM

(71) Applicant: Sharp Kabushiki Kaisha, Sakai City, Osaka (JP)

(72) Inventor: Yasuaki TOKUMO, Sakai City (JP)

(21) Appl. No.: 16/971,320

(22) PCT Filed: Feb. 20, 2019
(86) PCT No.: PCT/JP2019/006377

§ 371 Date: Aug. 20, 2020

(30) Foreign Application Priority Data
Feb. 27, 2018 (JP) 2018-033661

(51) Int. Cl. H04N 13/282; H04N 13/117; H04N 13/178

(52) U.S. Cl. CPC H04N 13/282; H04N 13/178; H04N 13/117

(57) ABSTRACT

Provided is a generation apparatus that generates structured data with which a reconstruction apparatus can easily specify and acquire a preferable virtual viewpoint image. A generation apparatus (2) includes a virtual viewpoint image generation unit (11), and a data generation unit (12) configured to generate structured data, in which the data generation unit (12) includes, in the structured data, subset data defining one or more prescribed ranges identifiable from each other, each of the one or more prescribed ranges including one or more virtual viewpoint positions.

### TECHNICAL FIELD

An aspect of the present invention relates to a generation apparatus of structured data, a reconstruction apparatus of a virtual viewpoint image, a generation method of structured data, a control program, and a recording medium in which the control program is described.

### BACKGROUND ART

In recent years, various techniques have been developed for streaming distribution of a large capacity of video, such as a multi-viewpoint image, an entire celestial sphere image, or the like. Examples of such techniques include Dynamic Adaptive Streaming over HTTP (DASH) which is being standardized by Moving Picture Experts Group (MPEG). In DASH, formats of description information called Media Presentation Description (MPD) data and Segment data are defined.

### CITATION LIST

### Non Patent Literature

NPL 1: ISO/IEC 23009-1 Second edition 2014-05-15

### SUMMARY OF INVENTION

### Technical Problem

However, the existing technique as described above has a problem that, in a case that a reconstruction apparatus that performs image reconstruction processing acquires a virtual viewpoint image from a generation apparatus or the like that performs image generation processing, and generates an image with a viewpoint position, it is difficult to determine the virtual viewpoint image to be acquired from the generation apparatus or the like.

An aspect of the present invention has been made in view of the problem described above, and an object of the present invention is to provide a generation apparatus that generates structured data with which a reconstruction apparatus can easily specify and acquire a preferable virtual viewpoint image.

### Solution to Problem

In order to solve the above-described problem, a generation apparatus according to an aspect of the present invention includes: a virtual viewpoint image generation unit configured to generate a virtual viewpoint image on a per section basis in a virtual space; and a data generation unit configured to generate structured data indicating an acquisition source of a piece of data constituting the virtual viewpoint image, in which the data generation unit includes, in the structured data, subset data defining one or more prescribed ranges identifiable from each other, each of the one or more prescribed ranges including one or more virtual viewpoint positions in the virtual space.

### Advantageous Effects of Invention

According to an aspect of the present invention, it is possible to implement a generation apparatus that generates structured data with which a reconstruction apparatus can easily specify and acquire an image at a preferable virtual viewpoint position.

### BRIEF DESCRIPTION OF DRAWINGS

FIG. 1 is a functional block diagram of an image reconstruction system according to Embodiment 1.

FIG. 2 is a diagram illustrating an example of a virtual space and MPD data indicating a virtual viewpoint image.

FIG. 3 is a schematic diagram illustrating an example of a user moving in the virtual space.

FIG. 4 is a diagram illustrating an example of the MPD data including subset data indicating a sub-space.

FIG. 5 is a diagram illustrating an example of the above-described subset data included in the MPD data by a data generation unit.

FIG. 6 is a flowchart illustrating a flow of processing according to Embodiment 1.

FIG. 7 is a schematic diagram illustrating an example in which one virtual viewpoint image is made to correspond to multiple AdaptationSet elements.

FIG. 8 is a diagram illustrating an example of the MPD data generated by the data generation unit in Modification 1 of Embodiment 1.

FIG. 9 is a diagram illustrating an example of the above-described subset data included in the MPD data by the data generation unit.

FIG. 10 is a diagram illustrating an example of a virtual space that is a three-dimensional space.

FIG. 11 is a diagram illustrating an example of the MPD data generated by the data generation unit in Modification 2 of Embodiment 1.

FIG. 12 is a diagram illustrating an example of subset data included in the MPD data by the data generation unit.

FIG. 13 is a schematic diagram illustrating an example of the user moving in the virtual space.

FIG. 14 is a diagram illustrating a state in which a user is positioned at a position in the virtual space.

FIG. 15 is a diagram illustrating the MPD data, which are data obtained by structuring respective acquisition sources of the data constituting the virtual viewpoint images.

FIG. 16 is a diagram illustrating a description example of AdaptationSet included in the MPD data according to Embodiment 2.

FIG. 17 is a diagram illustrating an example of an arrangement pattern of virtual viewpoint images.

FIG. 18 is a diagram illustrating the MPD data, which are data obtained by structuring respective acquisition sources of media segments constituting the virtual viewpoint images.

FIG. 19 is a diagram illustrating a description example of the MPD data according to Embodiment 3.

FIG. 20 is a diagram illustrating an example of an arrangement pattern of virtual viewpoint images.

FIG. 21 is a diagram illustrating a description example of the MPD data according to a modification of Embodiment 3.

FIG. 22 is a flowchart illustrating a flow of processing according to Embodiment 2.

FIG. 23 is a flowchart illustrating a flow of processing according to Embodiment 3.

### DESCRIPTION OF EMBODIMENTS

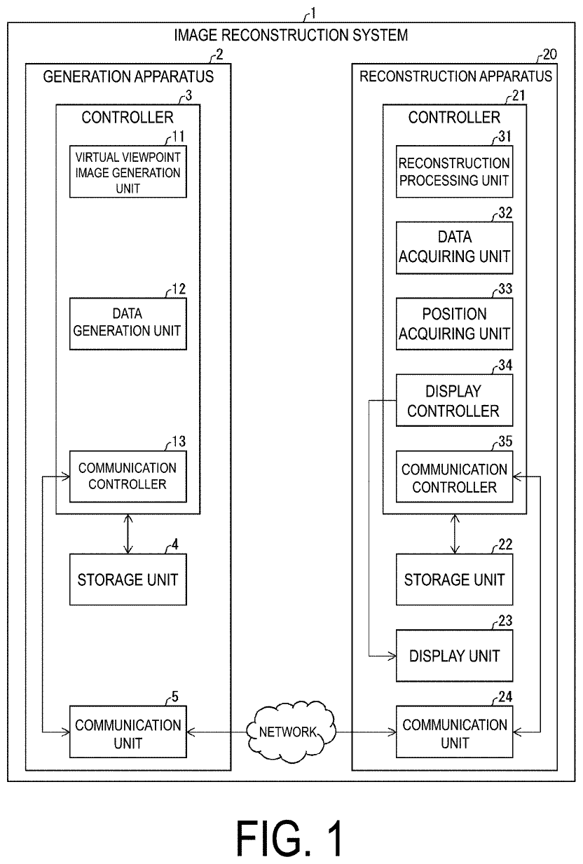

Embodiments of the present invention will be described as follows with reference to FIG. 1 to FIG. 21.

### Embodiment 1

An embodiment of the present invention will be described below with reference to FIG. 1 to FIG. 13.

In the present embodiment, a configuration of an image reconstruction system that defines a sub-space in a virtual viewpoint space will be described. Note that in the present specification, unless otherwise stated, a still image and a moving image are not distinguished, and both are referred to as images.

### 1. Configuration of Image Reconstruction System 1

A configuration of an image reconstruction system 1 according to the present embodiment will be described with reference to FIG. 1. FIG. 1 is a functional block diagram of the image reconstruction system 1 according to the present embodiment. As illustrated in FIG. 1, the image reconstruction system 1 includes a generation apparatus 2 and a reconstruction apparatus 20.

The generation apparatus 2 is an apparatus configured to generate each virtual viewpoint image in a virtual space and Media Presentation Description (MPD) data, which are structured data indicating an acquisition source of a piece of data (media segment) constituting the virtual viewpoint image. Note that the virtual viewpoint image refers to a viewpoint image at a viewpoint position in the virtual space. Additionally, details of the MPD data will be described later.

The generation apparatus 2 includes a controller 3, a storage unit 4, and a communication unit 5. The controller 3 is a control device that integrally controls the generation apparatus 2 as a whole, and includes a virtual viewpoint image generation unit 11, a data generation unit 12, and a communication controller 13.

The virtual viewpoint image generation unit 11 generates a virtual viewpoint image at a virtual viewpoint position in the virtual space. The data generation unit 12 generates the MPD data described above. The communication controller 13 performs control related to communication processing by the communication unit 5.

The storage unit 4 is a storage device configured to store various data. The communication unit 5 performs communication processing with an external device via a network.

The reconstruction apparatus 20 is an apparatus configured to acquire a piece of data constituting the virtual viewpoint image with reference to the MPD data described above, and reconstruct the virtual viewpoint image. The reconstruction apparatus 20 includes a controller 21, a storage unit 22, a display unit 23, and a communication unit 24.

The controller 21 is a control device that integrally controls the reconstruction apparatus 20 as a whole, and includes a reconstruction processing unit 31, a data acquiring unit 32, a position acquiring unit 33, a display controller 34, and a communication controller 35.

The reconstruction processing unit 31 performs processing for generating the virtual viewpoint image from the media segment. The data acquiring unit 32 acquires the MPD data and the media segment. The position acquiring unit 33 acquires a position and posture (orientation) of a user in the virtual space. A display acquiring unit performs control related to picture display processing by the display unit 23. The communication controller 35 performs control related to communication processing by the communication unit 24.

The storage unit 22 is a storage device configured to store various data. The display unit 23 is a display panel configured to perform display processing of a moving image or a still image. The communication unit 24 performs communication processing with an external device via a network.

### 2. MPD Data

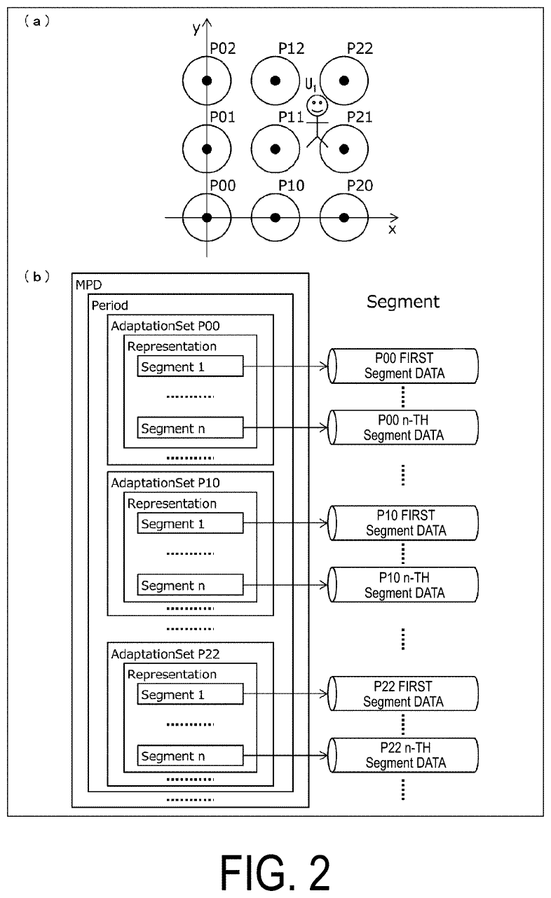

The virtual viewpoint image and the MPD data generated by the generation apparatus 2 in the present embodiment will be described with reference to FIG. 2 to FIG. 5.

FIG. 2 is a diagram illustrating an example of the virtual space and the MPD data indicating the virtual viewpoint image. FIG. 2(a) is a diagram illustrating a state in which a user is positioned at a position in the virtual space. A circular figure present at each lattice point, such as P00 or the like, represents a virtual viewpoint image at the viewpoint position. Here, the virtual viewpoint image is an entire celestial sphere image or an image equivalent to the entire celestial sphere image. Furthermore, the viewpoint position of the virtual viewpoint image generated by the generation apparatus 2 is not necessarily limited to the position of the lattice point in the coordinate system in the virtual space.

As illustrated in FIG. 2(a), the virtual viewpoint image generation unit 11 generates a virtual viewpoint image on a per section basis in the virtual space, and stores, in the storage unit 4 or a storage device which is not illustrated in FIG. 1, a media segment, which is a piece of data constituting each virtual viewpoint image, so as to be able to be referred to by the MPD data described later.

FIG. 2(b) is a diagram illustrating the MPD data, which are data obtained by structuring respective acquisition sources of the data constituting the virtual viewpoint images. The MPD data are, as illustrated in FIG. 2(b), have a hierarchical structure of an MPD element, a Period element, an AdaptationSet element, a Representation element, a SegmentList element, and a SegmentURL element in order from the highest hierarchy. In addition, in FIG. 2(b), each of the SegmentList elements and each of the SegmentURL elements including Segment 1 to Segment n are omitted.

Here, one virtual viewpoint image as included in FIG. 2(a) corresponds to one AdaptationSet in the MPD data as illustrated in FIG. 2(b). For example, Segment 1 to Segment n included in AdaptationSet P00 in FIG. 2(b) are SegmentURL elements that respectively indicate the acquisition sources of n media segments (n is an integer of 1 or greater) that constitute the virtual viewpoint image P00 of FIG. 2(a).

In the image reconstruction system 1, in the virtual space, a prescribed range including one or more virtual viewpoint positions is defined as a sub-space.

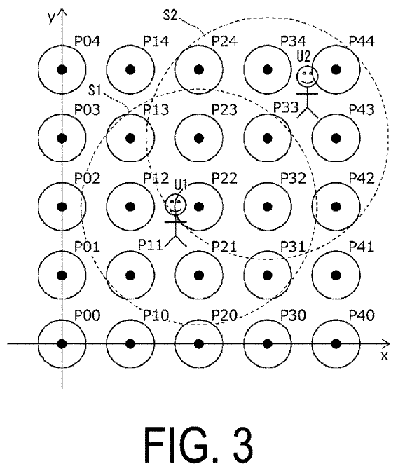

FIG. 3 is a schematic diagram illustrating an example of a user moving in the virtual space. In the example illustrated in FIG. 3, the user has moved from a virtual viewpoint position U1 included in a sub-space S1 defined in the virtual space to a virtual viewpoint position U2 included in a sub-space S2. Note that adjacent sub-spaces include one or more of common virtual viewpoint positions.

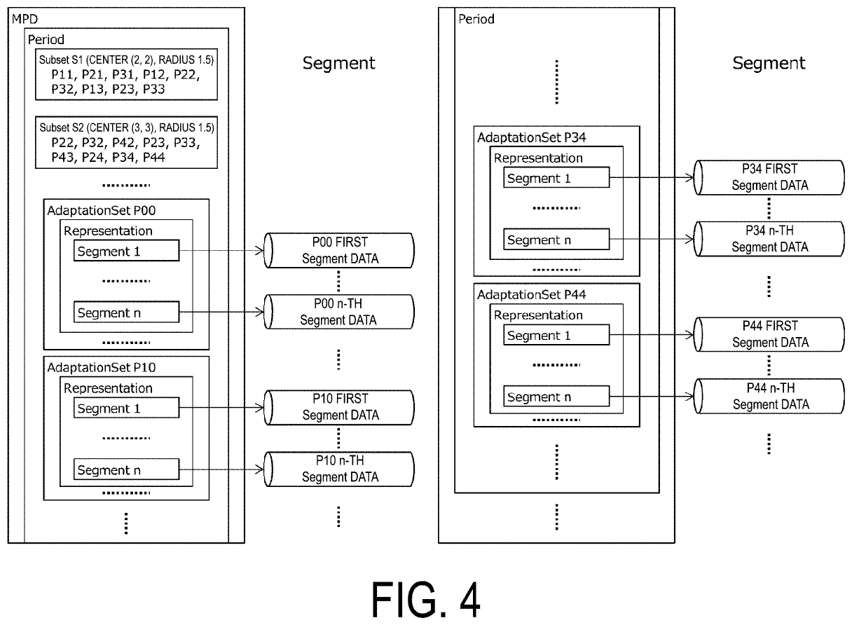

FIG. 4 is a diagram illustrating an example of the MPD data including subset data indicating the sub-space.

The data generation unit 12 generates the MPD data including the subset data defining one or more prescribed ranges identifiable from each other, each of the one or more prescribed ranges including one or more virtual viewpoint positions in the virtual space as illustrated in Subset S1 and Subset S2 in FIG. 4.

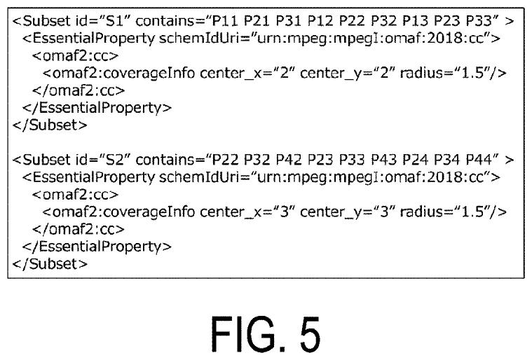

FIG. 5 is a diagram illustrating an example of the above-described subset data included in the MPD data by the data generation unit 12. As illustrated in FIG. 5, the subset data may include identification numbers of included virtual viewpoint positions (P11, P21, and the like in FIG. 5), and the center position (center_x and center_y), the radius, and the like of the sub-space.

### 3. Flow of Processing

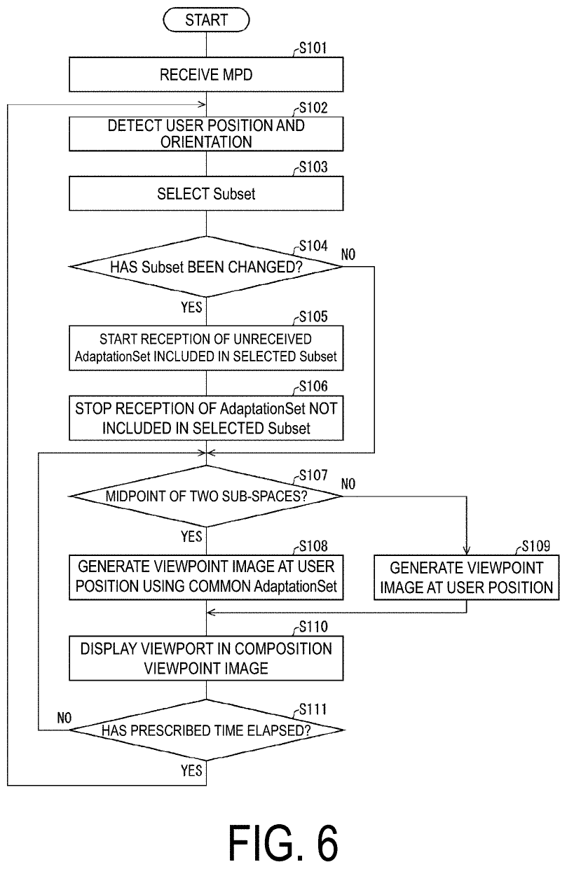

The flow of processing according to the virtual viewpoint image reconstruction according to the present embodiment will be described for each step with reference to FIG. 1 to FIG. 6. FIG. 6 is a flowchart illustrating the flow of processing according to the present embodiment. Hereinafter, as an example, as illustrated in FIG. 3, a case in which the user moves from the subset S1 to the subset S2 in the virtual space is assumed and described.

### S101

In step S101, the reconstruction apparatus 20 receives the MPD data. The communication controller 13 included in the generation apparatus 2 transmits, via the communication unit 5, the MPD data including the subset data described above as illustrated in FIG. 4 to the reconstruction apparatus 20. The data acquiring unit 32 acquires the MPD data via the communication unit 24 and stores the acquired data in the storage unit 22.

### S102

Next, in step S102, the position acquiring unit 33 acquires a position and posture of the user in the virtual space.

### S103

Next, in step S103, the controller 21 selects a subset in which the user is positioned with reference to the MPD data stored in the storage unit 22 in step S101 and the position of the user acquired by the position acquiring unit 33 in step S102.

### S104

Next, in step S104, the controller 21 determines whether or not the sub-space (subset) in which the user is positioned has been changed. In a case that the sub-space in which the user is positioned has been changed or in a case that the process transitions to present step S104 for the first time, the process transitions to step S105, and in a case that there is no change in the sub-space in which the user is positioned, the process transitions to step S107.

### S105

In step S105, the data acquiring unit 32 acquires, with reference to AdaptationSet corresponding to each of the virtual viewpoint positions included in the sub-space in which the user is positioned, the media segments constituting each virtual viewpoint image via the communication unit 24, and stores them in the storage unit 22.

### S106

Next, in step S106, the data acquiring unit 32 stops acquisition of the media segments included in AdaptationSet corresponding to each of the virtual viewpoint positions included in the subset other than the subset selected by the controller 21 in step S103.

### S107

Next, in step S107, the position acquiring unit 33 determines whether or not the user is positioned in a common range of multiple sub-spaces, that is, an overlap range. In a case that the user is positioned in the common range of multiple sub-spaces, the process transitions to step S108, and in a case of not being positioned, the process transitions to step S109.

### S108

In step S108, the reconstruction processing unit 31 generates the virtual viewpoint image at the virtual viewpoint position of the user, by composing the media segments included in AdaptationSet corresponding to each of the virtual viewpoint positions included in the common range of the sub-space in step S107 in which the user is positioned. Furthermore, in this step, the data acquiring unit 32 may stop acquisition of the media segments included in AdaptationSet other than each of the AdaptationSet elements described above. Processing in this step is performed and then the process transitions to step S110.

### S109

In step S109, the reconstruction processing unit 31 generates the virtual viewpoint image at the virtual viewpoint position of the user, from the media segments corresponding to each of the virtual viewpoint position included in the sub-space in which the user is positioned.

### S110

In step S110, the display controller 34 causes, with reference to the virtual viewpoint image generated by the reconstruction processing unit 31 in step S108 or step S109, and the position and posture of the user acquired by the position acquiring unit 33 in step S102, the display unit 23 to display an image corresponding to a field of view from the virtual viewpoint position of the user.

### S111

Next, in step S111, the controller 21 determines whether or not a prescribed time has elapsed since the count has started in this step. In a case that the prescribed time has elapsed, the process transitions to step S102, and in a case of the time has not elapsed, the process transitions to step S107.

In other words, the reconstruction apparatus 20 iterates a flow from the processing in which the position acquiring unit 33 acquires the position and posture of the user in the virtual space in step S102 to the processing in which the display processing unit causes the display unit 23 to display the image corresponding to the field of view from the virtual viewpoint position of the user in step S110, until the user performs a prescribed termination operation, or until the moving image indicated by the MPD data stored in the storage unit 22 in step S101 is terminated. The flow of processing according to the flowchart of FIG. 6 has been described above.

As described above, the generation apparatus 2 according to the present embodiment includes: the virtual viewpoint image generation unit 11 configured to generate a virtual viewpoint image on a per section basis in a virtual space; and the data generation unit 12 configured to generate structured data indicating an acquisition source of a piece of data constituting the virtual viewpoint image, in which the data generation unit 12 includes, in the structured data, subset data defining one or more prescribed ranges identifiable from each other, each of the one or more prescribed ranges including one or more virtual viewpoint positions in the virtual space.

According to the above-described configuration, it is possible to implement the generation apparatus 2 that generates structured data with which the reconstruction apparatus 20 can easily specify and acquire an image of a preferable virtual viewpoint position.

Furthermore, the reconstruction apparatus 20 according to the present embodiment includes: the data acquiring unit 32 configured to acquire structured data indicating an acquisition source of a piece of data constituting a virtual viewpoint image generated on a per section basis in a virtual space, the structured data including subset data defining one or more prescribed ranges identifiable from each other, each of the prescribed ranges including one or more virtual viewpoint positions in the virtual space; and the position acquiring unit 33 configured to acquire a position of a user in the virtual space, in which the data acquiring unit 32 acquires, with reference to the structured data and the position of the user acquired by the position acquiring unit 33, a piece of data constituting the virtual viewpoint image corresponding to a virtual viewpoint position of the one or more virtual viewpoint positions included in a prescribed range of the one or more prescribed ranges in which the user is present.

According to the above-described configuration, it is possible to implement the reconstruction apparatus 20 that can easily specify and acquire an image of a preferable virtual viewpoint position.

### Modification 1

A first modification of Embodiment 1 will be described with reference to FIG. 1 and FIG. 7 to FIG. 9. Note that, for the sake of convenience, members having the same functions as the members described in the above embodiment are denoted by the same reference signs, and descriptions thereof will be omitted. In the present modification, a configuration in which one virtual viewpoint image is made to correspond to multiple AdaptationSet elements will be described.

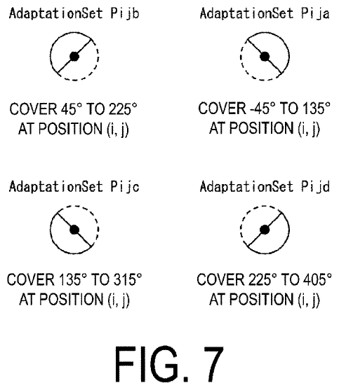

FIG. 7 is a schematic diagram illustrating an example in which one virtual viewpoint image is made to correspond to multiple AdaptationSet elements. Here, each diagram in FIG. 7 is a diagram of the range of the virtual viewpoint image covered by each AdaptationSet, viewed from the above. Additionally, as illustrated in FIG. 7, the ranges may partially overlap with one another.

The virtual viewpoint image generation unit 11 generates the virtual viewpoint image on a per section basis in the virtual space, and stores the media segments constituting each virtual viewpoint image in the storage unit 4 or in a storage device which is not illustrated in FIG. 1 such that each virtual viewpoint image can be referred to by multiple AdaptationSet elements.

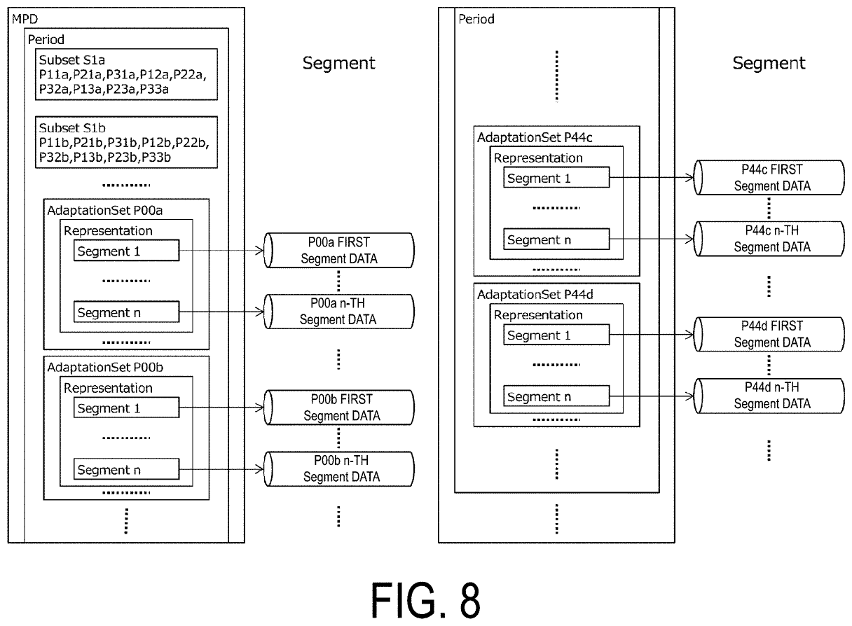

FIG. 8 is a diagram illustrating an example of the MPD data generated by the data generation unit 12 in the present modification. In the example illustrated in FIG. 8, for example, a virtual viewpoint image P00 generated by the virtual viewpoint image generation unit 11 corresponds to AdaptationSet elements P00a to P00d (P00c and P00d are not illustrated). Furthermore, the data generation unit 12 includes, as illustrated in Subset S1a and Subset S1b in FIG. 8, in the MPD data, subset data defining one or more virtual viewpoint images covering a prescribed range.

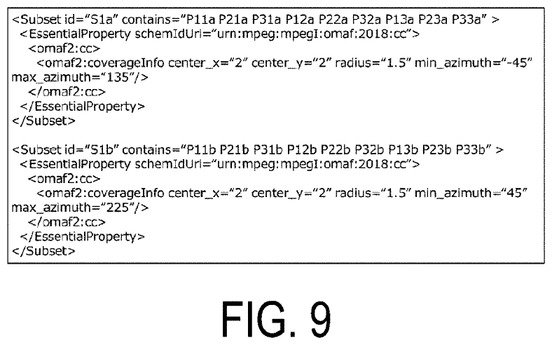

FIG. 9 is a diagram illustrating an example of the above-described subset data included in the MPD data by the data generation unit 12. As illustrated in FIG. 9, the subset data may include, in addition to identification numbers of included virtual viewpoint positions (P11a, P21a, and the like in FIG. 9) and the center position (center_x and center_y), the radius, and the like of the sub-space, information (min_azimuth and max_azimuth) indicating which range (angle) the virtual viewpoint image corresponding to the subset covers, and the like.

The data acquiring unit 32 included in the reconstruction apparatus 20 acquires the MPD data as illustrated in FIG. 8 from the generation apparatus 2, and stores the acquired data in the storage unit 22.

In the present modification, in processing corresponding to step S103 of Embodiment 1, the controller 21 selects a subset in which the user is positioned with reference to the MPD data stored in the storage unit 22 and the position and posture (orientation) of the user in the virtual space acquired by the position acquiring unit 33.

According to the above-described configuration, since the data acquiring unit 32 does not acquire the virtual viewpoint image in a direction in which the user's position is not oriented, an effect of reducing the amount of communication processing can be achieved.

### Modification 2

A second modification of Embodiment 1 will be described with reference to FIG. 1 and FIG. 10 to FIG. 13. Note that, for the sake of convenience, members having the same functions as the members described in the above embodiment are denoted by the same reference signs, and descriptions thereof will be omitted. In the present modification, a configuration in which a user is positioned in a virtual three-dimensional space will be described.

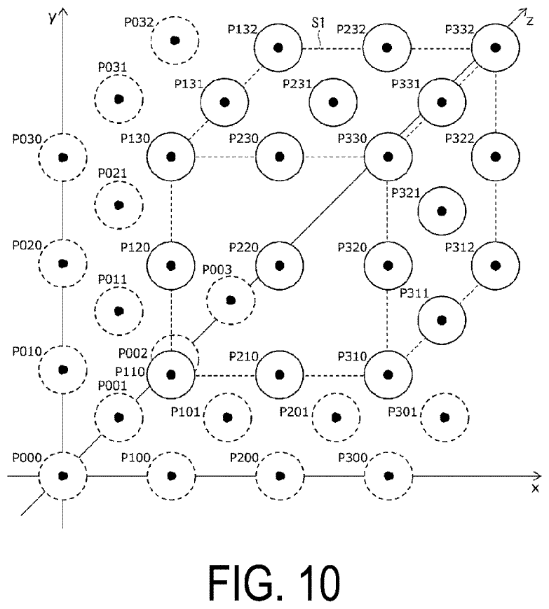

FIG. 10 is a diagram illustrating an example of a virtual space that is the three-dimensional space. As illustrated in FIG. 10, the virtual viewpoint image generation unit 11 according to the present modification generates a virtual viewpoint image on a per section basis in the three-dimensional virtual space, and stores, in the storage unit 4 or a storage device which is not illustrated in FIG. 1, the media segment, which is a piece of data constituting each virtual viewpoint image, so as to be able to be referred to by the MPD data.

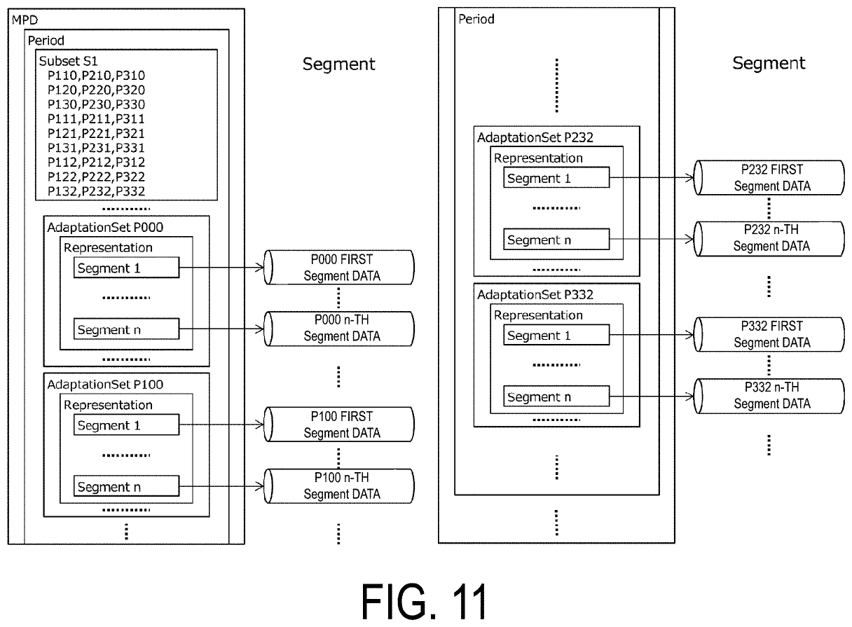

FIG. 11 is a diagram illustrating an example of the MPD data generated by the data generation unit 12 in the present modification.

The data generation unit 12 generates the MPD data including the subset data, which indicate the sub-space, defining one or more prescribed ranges identifiable from each other, each of the one or more prescribed ranges including one or more virtual viewpoint positions in the three-dimensional virtual space as illustrated in Subset S1 in FIG. 11. Additionally, in the present modification as well, the adjacent sub-spaces include one or more of common virtual viewpoint positions.

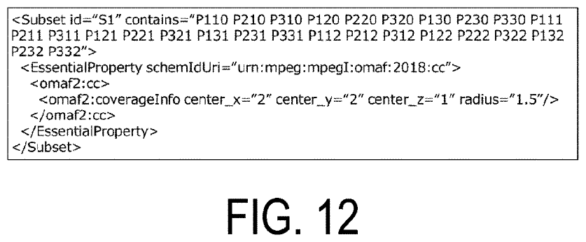

FIG. 12 is a diagram illustrating an example of the subset data included in the MPD data by the data generation unit 12. As illustrated in FIG. 12, the subset data may include identification numbers of included virtual viewpoint positions (P110, P210, and the like in FIG. 12), and the center position (center_x, center_y, and center_z), the radius, and the like of the sub-space in the three-dimensional space.

In the present modification as well, in the same manner as Embodiment 1, the reconstruction apparatus 20 refers to the MPD data, receives the media segments corresponding to the subset in which the user is positioned, and uses them for subsequent processing.

According to the above-described configuration, even in a case that the user is positioned in the virtual three-dimensional space, the reconstruction apparatus 20 can easily specify an image of a preferable virtual viewpoint position.

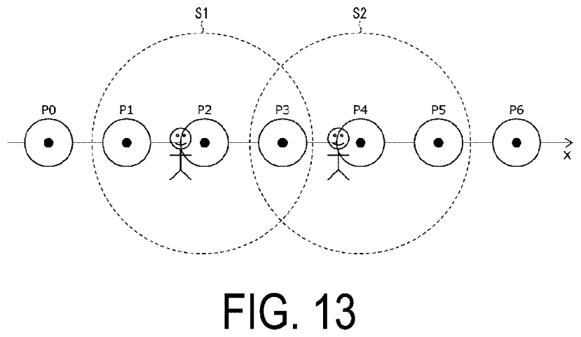

Furthermore, FIG. 13 is a schematic diagram illustrating an example of the user moving in the virtual space. The above-described configuration using the MPD data including the subset is applicable even in a case that the virtual viewpoint image generation unit 11 generates a virtual viewpoint image at a position on a one-dimensional straight line and the user moves on the straight line in the virtual space.

Note that the above-described Modification 1 and Modification 2 can be appropriately applied to the embodiments described below.

### Embodiment 2

A second embodiment of the present invention will be described with reference to FIG. 1 and FIG. 14 to FIG. 16. In the present embodiment, a configuration of the image reconstruction system 1 that defines a composition level for each virtual viewpoint image will be described. Note that, for the sake of convenience of description, members having the same functions as the members described in the above embodiment are denoted by the same reference signs, and descriptions thereof will not be repeated.

### 1. Configuration of Image Reconstruction System 1

The configuration illustrated in FIG. 1 is used also in the present embodiment. Note that the virtual viewpoint image generation unit 11 according to the present embodiment has a function of recursively generating a virtual viewpoint image from a generated virtual viewpoint image. In addition, in a case that the MPD data are generated, the data generation unit 12 includes, in AdaptationSet corresponding to each virtual viewpoint image, composition level data indicating the number of times of recursive composition through which the virtual viewpoint image viewpoint is generated.

### 2. MPD Data

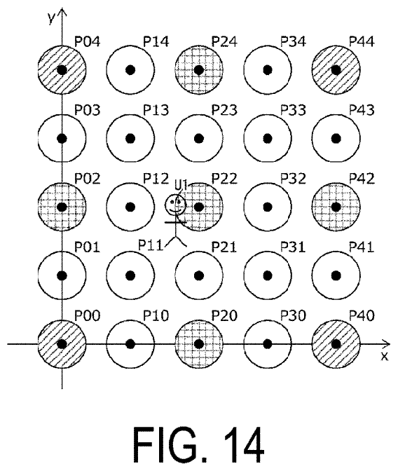

The virtual viewpoint image and the MPD data generated by the generation apparatus in the present embodiment will be described with reference to FIG. 14 to FIG. 16.

FIG. 14 is a diagram illustrating a state in which the user is positioned at a position in the virtual space. Here, the virtual viewpoint images can be roughly classified into zero-order virtual viewpoint images (P00, P04, P40, and P44 in FIG. 14) which are captured image by a camera, primary virtual viewpoint images (P20, P02, P22, P42, and P24), and secondary virtual viewpoint images (P10, P30, and the like).

The virtual viewpoint image generation unit 11 generates the primary virtual viewpoint images from the multiple zero-order virtual viewpoint images, and generates the secondary virtual viewpoint images from the multiple zero-order or primary virtual viewpoint images.

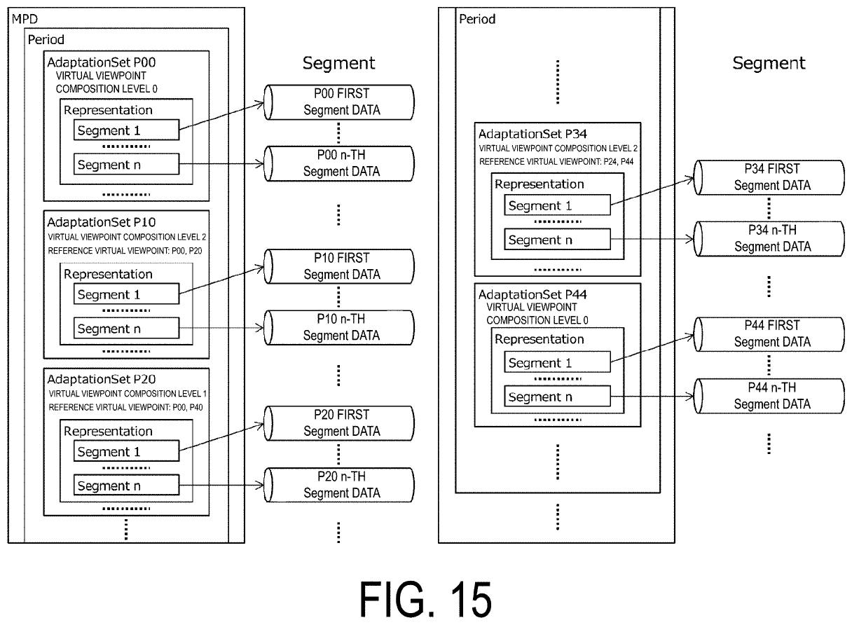

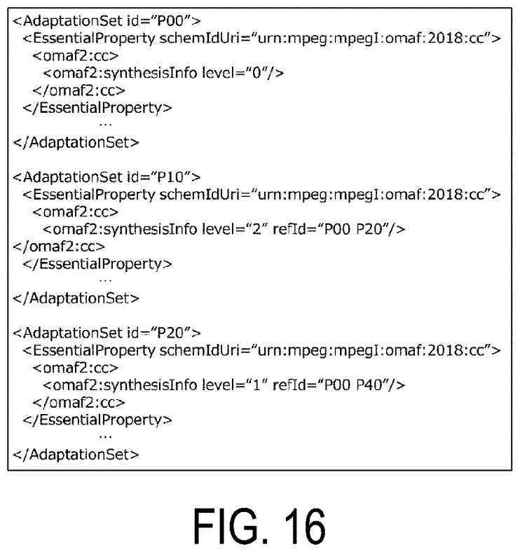

FIG. 15 is a diagram illustrating the MPD data, which are data obtained by structuring respective acquisition sources of the data constituting the virtual viewpoint images. Furthermore, FIG. 16 is a diagram illustrating a description example of AdaptationSet included in the MPD data according to the present embodiment.

As illustrated in a virtual viewpoint composition level in FIG. 15 and the level in FIG. 16, AdaptationSet corresponding to each virtual viewpoint image includes composition level data, which are information indicating a classification of the classifications described above (zero-order, primary, or secondary virtual viewpoint image) to which the virtual viewpoint image belongs. Additionally, as illustrated in a reference virtual viewpoint in FIG. 15 and a refID in FIG. 16, each AdaptationSet may include information indicating the viewpoint position to refer to the corresponding virtual viewpoint position to generate the virtual viewpoint image corresponding to the AdaptationSet.

### 3. Flow of Processing

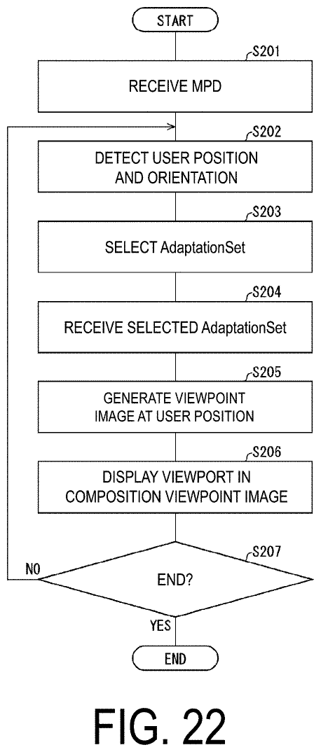

The flow of processing according to the virtual viewpoint image reconstruction according to the present embodiment will be described for each step with reference to FIG. 1, FIG. 14 to FIG. 16, and FIG. 22. FIG. 22 is a flowchart illustrating the flow of processing according to the present embodiment.

### S201

In step S201, the reconstruction apparatus 20 receives the MPD data. The communication controller 13 included in the generation apparatus 2 transmits, via the communication unit 5, the MPD data including the composition level data described above as illustrated in FIG. 15 to the reconstruction apparatus 20. The data acquiring unit 32 acquires the MPD data via the communication unit 24 and stores the acquired data in the storage unit 22.

### S202

Next, in step S202, the position acquiring unit 33 acquires a position and posture of the user in the virtual space. Additionally, the controller 21 calculates a velocity at which the user moves in the virtual space by referring to position information of the user acquired by the position acquiring unit 33 as needed.

### S203

Next, in step S203, the data acquiring unit 32 determines, with reference to the composition level data included in AdaptationSet in the MPD data stored in the storage unit 22 in step S201, and the position of the user acquired by the position acquiring unit 33 in step S202 and the velocity of the user calculated by the controller 21, the virtual viewpoint image to be acquired. For example, the data acquiring unit 32 may be configured such that, in a case that the user moves at high velocity, even in a case that the virtual viewpoint image corresponds to the virtual viewpoint position on the movement path of the user, the virtual viewpoint image is not acquired in a case of being the secondary virtual viewpoint image described above.

Alternatively, in a case that the communication speed in the network between the generation apparatus 2 and the reconstruction apparatus 20 is slow, and the overall processing speed in the image reconstruction system 1 is faster in a case that the reconstruction apparatus 20 side generates the primary virtual viewpoint image, the secondary virtual viewpoint image, or both of them, the data acquiring unit 32 may be configured so as not to acquire the primary virtual viewpoint image, the secondary virtual viewpoint image, or both of them from the generation apparatus 2.

### S204

Next, in step S204, the data acquiring unit 32 acquires, with reference to the MPD data stored in the storage unit 22 in step S201, the media segments constituting the virtual viewpoint image that has been determined to be acquired in step S203, and stores them in the storage unit 22.

### S205

Next, in step S205, the reconstruction processing unit 31 generates the virtual viewpoint image at the virtual viewpoint position on the movement path of the user, by composing the media segments stored in the storage unit 22 at step S204.

### S206

Next, in step S206, the display controller 34 causes, with reference to the virtual viewpoint image generated by the reconstruction processing unit 31 in step S205, and the position and posture of the user acquired by the position acquiring unit 33 in step S202, the display unit 23 to display an image corresponding to a field of view from the virtual viewpoint position of the user. The above description is processing in step S206.

The reconstruction apparatus 20 iterates processing from the processing in which the position acquiring unit 33 acquires the position and posture of the user in the virtual space in step S202 to the processing in which the display processing unit causes the display unit 23 to display the image corresponding to the field of view from the virtual viewpoint position of the user in step S206, until the user performs a prescribed termination operation, or until the moving image indicated by the MPD data stored in the storage unit 22 in step S201 is terminated.

As described above, the generation apparatus 2 according to the present embodiment includes: the virtual viewpoint image generation unit 11 configured to generate a virtual viewpoint image on a per section basis in a virtual space; and the data generation unit 12 configured to generate structured data indicating an acquisition source of a piece of data constituting the virtual viewpoint image, in which the virtual viewpoint image generation unit 11 recursively generates a virtual viewpoint image from a generated virtual viewpoint image, and the data generation unit 12 includes, in a data group constituting the virtual viewpoint image of the structured data, composition level data indicating the number of times of recursive composition through which the virtual viewpoint image is generated.

According to the above-described configuration, for example, in the reconstruction apparatus 20, in a case that the user moves in the virtual space at high velocity, the generation apparatus 2 can generate the MPD data that enable only a virtual viewpoint image minimum necessary for viewpoint composition to be acquired. Furthermore, the reconstruction apparatus 20 according to the present embodiment includes: the data acquiring unit 32 configured to acquire structured data indicating an acquisition source of a piece of data constituting a virtual viewpoint image generated on a per section basis in a virtual space, the structured data including, in a data group constituting a virtual viewpoint image, composition level data indicating the number of times of recursive composition through which the virtual viewpoint image is generated, in which the data acquiring unit 32 determines, with reference to the composition level data, the virtual viewpoint image to be acquired.

According to the above-described configuration, for example, in a case that the user moves in the virtual space at high velocity, the reconstruction apparatus 20 can acquire only a virtual viewpoint image minimum necessary for viewpoint composition and use it for image reconstruction, and an effect of reducing the amount of communication data and the like is achieved.

### Embodiment 3

A third embodiment of the present invention will be described with reference to FIG. 1 and FIG. 17 to FIG. 19. In the present embodiment, a configuration of the image reconstruction system 1 that defines an arrangement pattern of the virtual viewpoint images using identification numbers will be described. Note that, for the sake of convenience of description, members having the same functions as the members described in the above embodiments are denoted by the same reference signs, and descriptions thereof will not be repeated.

### 1. Configuration of Image Reconstruction System 1

The configuration illustrated in FIG. 1 is used also in the present embodiment. Note that the data generation unit 12 according to the present embodiment includes, in a case of generating the MPD data, in the data, arrangement pattern data indicating a virtual viewpoint position at which each of the virtual viewpoint images is arranged.

### 2. MPD Data

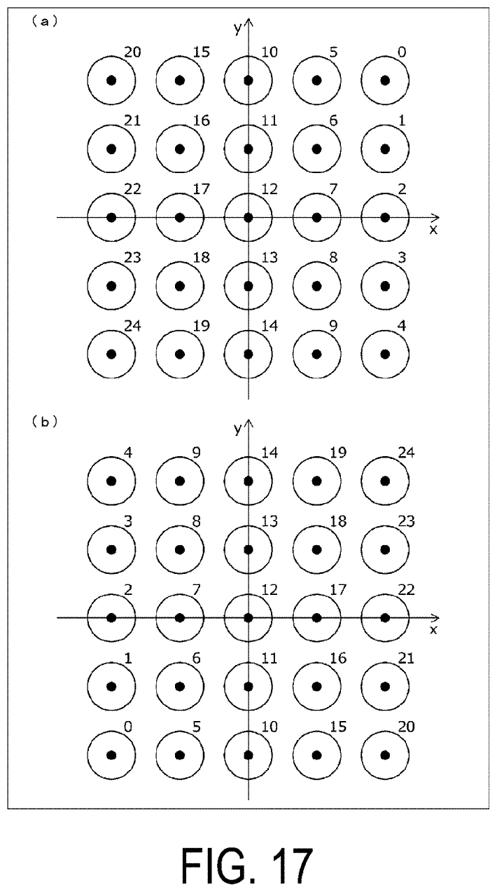

The virtual viewpoint image and the MPD data generated by the generation apparatus 2 in the present embodiment will be described with reference to FIG. 17 to FIG. 19.

FIG. 17 is a diagram illustrating an example of an arrangement pattern of the virtual viewpoint images. As illustrated in FIGS. 17(a) and (b), in the image reconstruction system 1 according to the present embodiment, an identification number is defined for a position of each virtual viewpoint image in the virtual space.

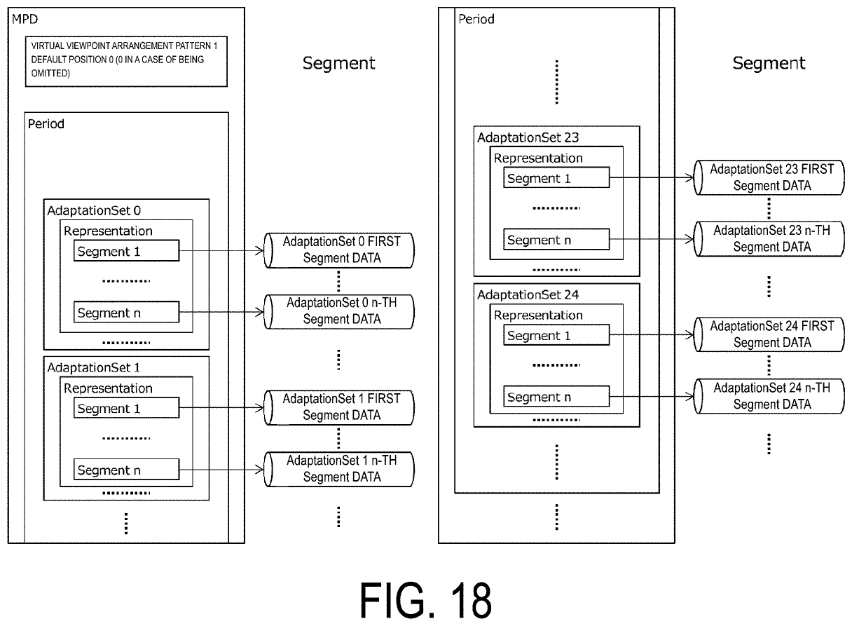

FIG. 18 is a diagram illustrating the MPD data, which are data obtained by structuring respective acquisition sources of media segments constituting the virtual viewpoint images. As illustrated in a virtual viewpoint arrangement pattern 1 in FIG. 18, the MPD data according to the present embodiment includes arrangement pattern data indicating a virtual viewpoint position at which each of the virtual viewpoint images is arranged. Note that information of what kind of arrangement of the virtual viewpoint positions the value of the arrangement pattern data indicates is shared beforehand between the generation apparatus 2 and the reconstruction apparatus 20.

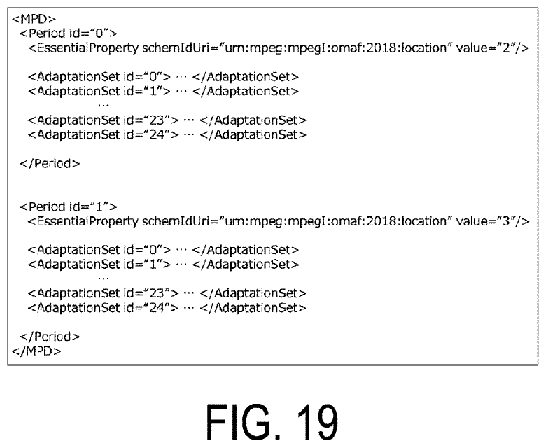

FIG. 19 is a diagram illustrating a description example of the MPD data according to the present embodiment. In the MPD data illustrated in FIG. 19, the value of a “value” indicates the arrangement pattern of the virtual viewpoints. As illustrated in FIG. 19, the data indicating the arrangement pattern of the virtual viewpoint positions may be configured so as to be included in the Period element rather than directly below the MPD data. Additionally, the Period elements included in the MPD data are elements corresponding to moving images obtained by being divided by prescribed times. In the following description using FIG. 19, it is assumed that the reconstruction apparatus 20 reconstructs a moving image corresponding to Period 0 with id=0, and then reconstructs a moving image corresponding to Period 1 with id=1.

### 3. Flow of Processing

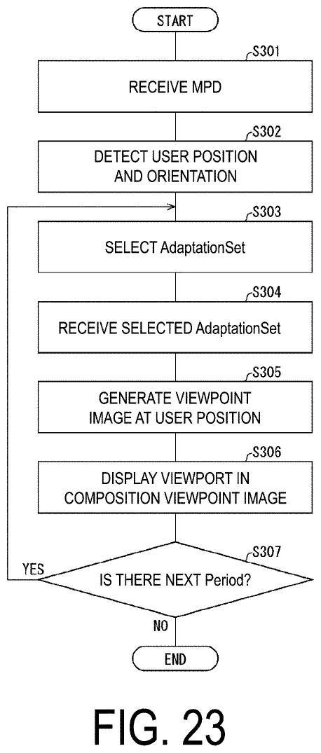

The flow of processing according to the virtual viewpoint image reconstruction according to the present embodiment will be described for each step with reference to FIG. 1, FIG. 17 to FIG. 19, and FIG. 23. FIG. 23 is a flowchart illustrating the flow of processing according to the present embodiment.

### S301

In step S301, the data acquiring unit 32 acquires the MPD data according to the present embodiment generated by the generation apparatus 2 via the communication unit 24, and stores the acquired data in the storage unit 22.

### S302

Next, in step S302, the position acquiring unit 33 acquires a position and posture of the user in the virtual space.

### S303

Next, in step S303, the data acquiring unit 32 determines, with reference to the arrangement pattern data included in the MPD data stored in the storage unit 22 in step S301, and the position of the user acquired by the position acquiring unit 33 in step S302 as appropriate, an AdaptationSet to acquire the corresponding virtual viewpoint image in reconstruction of a moving image corresponding to Period 0.

### S304

Next, in step S304, the data acquiring unit 32 acquires, with reference to the MPD data stored in the storage unit 22 in step S301, the media segments constituting the virtual viewpoint image that has been determined to be acquired in step S303, and stores them in the storage unit 22.

### S305

Next, in step S305, the reconstruction processing unit 31 generates the virtual viewpoint image at the virtual viewpoint position on the movement path of the user, by composing the media segments stored in the storage unit 22 at step S304.

### S306

Next, in step S306, the display controller 34 causes, with reference to the virtual viewpoint image generated by the reconstruction processing unit 31 in step S305, and the position and posture of the user acquired by the position acquiring unit 33 in step S302 as appropriate, the display unit 23 to display, for example, an image corresponding to a field of view from the virtual viewpoint position of the user.

### S307

Next, in step S307, in a case that a next Period is present, step 303 and subsequent processing are iterated. In the example of the MPD data illustrated in FIG. 19, although the arrangement pattern of the virtual viewpoint position in Period 0 and the arrangement pattern of the virtual viewpoint position in Period 1 are different from each other, for example, the data acquiring unit 32 may determine to acquire a virtual viewpoint image corresponding to AdaptationSet having the same id as AdaptationSet determined in step S303.

The generation apparatus 2 according to the present embodiment includes: the virtual viewpoint image generation unit 11 configured to generate a virtual viewpoint image on a per section basis in a virtual space; and the data generation unit 12 configured to generate structured data indicating an acquisition source of a piece of data constituting the virtual viewpoint image, in which the data generation unit 12 generates the structured data including arrangement pattern data indicating a virtual viewpoint position at which each of the virtual viewpoint images is arranged.

According to the above-described configuration, by preparing multiple kinds of arrangement pattern data and switching between Periods, it is possible to implement the generation apparatus 2 that allows an image to be reconstructed from a recommended viewpoint for each Period while the user is in a fixed position.

Furthermore, the reconstruction apparatus 20 according to the present embodiment includes: the data acquiring unit 32 configured to acquire structured data indicating an acquisition source of a piece of data constituting a virtual viewpoint image generated on a per section basis in a virtual space, the structured data including arrangement pattern data indicating a virtual viewpoint position at which each of the virtual viewpoint images is arranged, in which the data acquiring unit 32 determines, with reference to the arrangement pattern data, the virtual viewpoint image to be acquired.

According to the above-described configuration it is possible to implement the reconstruction apparatus 20 that reconstructs an image from a viewpoint recommended by the generation apparatus 2 side for each Period while the user is in a fixed position.

### Modification

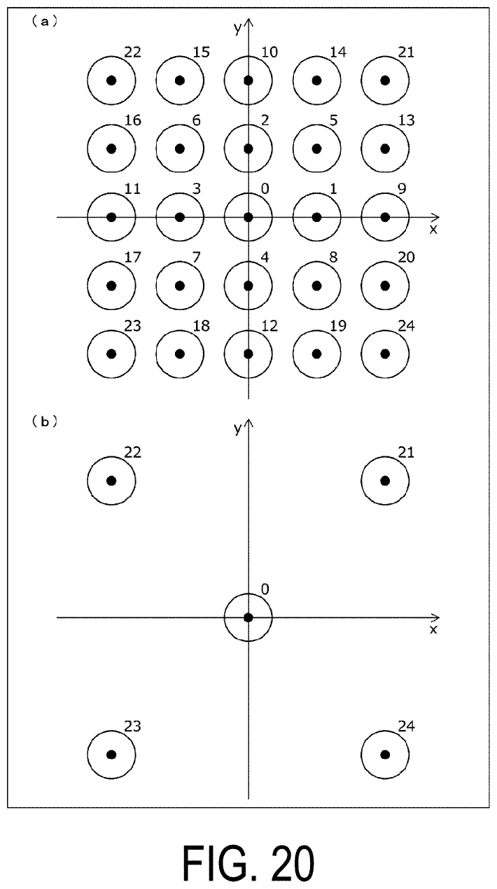

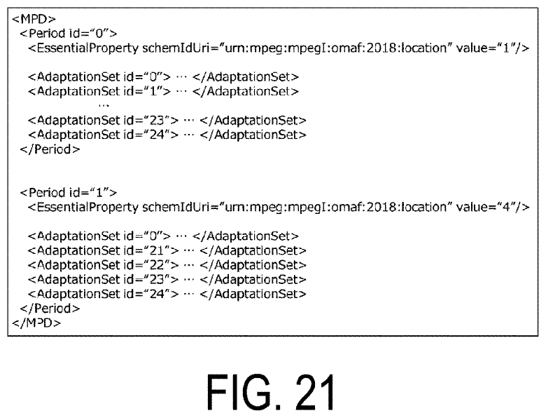

A modification of Embodiment 3 will be described with reference to FIG. 20 and FIG. 21. Note that, for the sake of convenience, members having the same functions as the members described in the above embodiments are denoted by the same reference signs, and descriptions thereof will be omitted. In the present modification, differences from Embodiment 3 in a configuration in which the virtual viewpoint images generated by the generation apparatus 2 are sparse in the virtual space, that is, a configuration including a relatively small number of images, will be described.

FIG. 20 is a diagram illustrating an example of the arrangement pattern of the virtual viewpoint images. Furthermore, FIG. 21 is a diagram illustrating a description example of the MPD data according to the present modification. The value “1” of a “value” in Period 0 included in the MPD data of FIG. 21 corresponds to the arrangement pattern of the virtual viewpoint images illustrated in FIG. 20(a), and the value “4” of a “value” in Period 1 corresponds to the arrangement pattern of the virtual viewpoint images illustrated in FIG. 20(b). As illustrated in FIG. 20 and FIG. 21, the number of virtual viewpoint images generated by the generation apparatus 2 may vary between Periods. The generation apparatus 2 does not generate a virtual viewpoint image that is not necessary for reconstruction by the reconstruction apparatus 20 in image reconstruction sections corresponding to some or all of Periods, and thereby an effect is achieved that reduces the amount of processing of virtual viewpoint image generation processing by the virtual viewpoint image generation unit 11 and the amount of data of the MPD data generated by the data generation unit 12.

### Implementation Examples by Software

The control blocks (in particular, the data generation unit 12) of the generation apparatus 2 and the control blocks (in particular, the reconstruction processing unit 31) of the reconstruction apparatus 20 may be implemented with a logic circuit (hardware) formed as an integrated circuit (IC chip) or the like, or may be implemented with software.

In the latter case, each of the generation apparatus 2 and the reconstruction apparatus 20 includes a computer that performs instructions of a program that is software for implementing each function. The computer includes at least one processor (control device), for example, and includes at least one computer-readable recording medium having the program stored thereon. On the computer, the processor reads the program from the recording medium and performs the program to achieve the object of the present invention. A Central Processing Unit (CPU) can be used as the processor, for example. As the above-described recording medium, a “non-transitory tangible medium” such as a tape, a disk, a card, a semiconductor memory, and a programmable logic circuit, for example, in addition to a Read Only Memory (ROM) and the like, can be used. Furthermore, a Random Access Memory (RAM) or the like for deploying the above-described program may be further provided. The above-described program may be supplied to the above-described computer via a transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

A generation apparatus 2 according to Aspect 1 of the present invention includes: a virtual viewpoint image generation unit 11 configured to generate a virtual viewpoint image on a per section basis in a virtual space; and a data generation unit 12 configured to generate structured data indicating an acquisition source of a piece of data constituting the virtual viewpoint image, in which the data generation unit 12 causes the structured data to include subset data defining one or more prescribed ranges identifiable from each other, each of the one or more prescribed ranges including one or more virtual viewpoint positions in the virtual space.

According to the above-described configuration, it is possible to implement the generation apparatus 2 that generates structured data with which the reconstruction apparatus 20 can easily specify and acquire an image of a preferable virtual viewpoint position.

A generation apparatus 2 according to Aspect 2 of the present invention includes: a virtual viewpoint image generation unit 11 configured to generate a virtual viewpoint image on a per section basis in a virtual space; and a data generation unit 12 configured to generate structured data indicating an acquisition source of a piece of data constituting the virtual viewpoint image, in which the virtual viewpoint image generation unit 11 recursively generates a virtual viewpoint image from the virtual viewpoint image that has been generated, and the data generation unit 12 causes a data group constituting the virtual viewpoint image of the structured data to include composition level data indicating the number of times of recursive composition through which the virtual viewpoint image is generated.

According to the above-described configuration, for example, in the reconstruction apparatus 20, in a case that the user moves in the virtual space at high velocity, the generation apparatus 2 can generate the MPD data that enable only a virtual viewpoint image minimum necessary for viewpoint composition to be acquired.

A generation apparatus 2 according to Aspect 3 of the present invention includes: a virtual viewpoint image generation unit 11 configured to generate a virtual viewpoint image on a per section basis in a virtual space; and a data generation unit 12 configured to generate structured data indicating an acquisition source of a piece of data constituting the virtual viewpoint image, in which the data generation unit 12 generates the structured data including arrangement pattern data indicating a virtual viewpoint position at which each of a plurality of the virtual viewpoint images is arranged.

According to the above-described configuration, by preparing multiple kinds of arrangement pattern data and switching between Periods, it is possible to implement the generation apparatus 2 that allows an image to be reconstructed from a recommended viewpoint for each Period while the user is in a fixed position.

A reconstruction apparatus 20 according to Aspect 4 of the present invention includes: a data acquiring unit 32 configured to acquire structured data indicating an acquisition source of a piece of data constituting a virtual viewpoint image generated on a per section basis in a virtual space, the structured data including subset data defining one or more prescribed ranges identifiable from each other, each of the one or more prescribed ranges including one or more virtual viewpoint positions in the virtual space; and a position acquiring unit 33 configured to acquire a position of a user in the virtual space, in which the data acquiring unit 32 acquires, with reference to the structured data and the position of the user acquired by the position acquiring unit 33, a piece of data constituting the virtual viewpoint image corresponding to a virtual viewpoint position of the one or more virtual viewpoint positions included in a prescribed range of the one or more prescribed ranges in which the user is present.

According to the above-described configuration, it is possible to implement the reconstruction apparatus 20 that can easily specify and acquire an image of a preferable virtual viewpoint position.

A reconstruction apparatus 20 according to Aspect 5 of the present invention includes: a data acquiring unit 32 configured to acquire structured data indicating an acquisition source of a piece of data constituting a virtual viewpoint image generated on a per section basis in a virtual space, the structured data including, in a data group constituting the virtual viewpoint image, composition level data indicating the number of times of recursive composition through which the virtual viewpoint is generated, in which the data acquiring unit 32 determines, with reference to the composition level data, the virtual viewpoint image to be acquired.

According to the above-described configuration, for example, in a case that the user moves in the virtual space at high velocity, the reconstruction apparatus 20 can acquire only a virtual viewpoint image minimum necessary for viewpoint composition and use it for image reconstruction, and thus achieving an effect of reducing the amount of communication data and the like.

A reconstruction apparatus 20 according to Aspect 6 of the present invention includes: a data acquiring unit 32 configured to acquire structured data indicating an acquisition source of a piece of data constituting a virtual viewpoint image generated on a per section basis in a virtual space, the structured data including arrangement pattern data indicating a virtual viewpoint position at which each of a plurality of the virtual viewpoint images is arranged, in which the data acquiring unit 32 determines, with reference to the arrangement pattern data, the virtual viewpoint image to be acquired.

According to the above-described configuration it is possible to implement the reconstruction apparatus 20 that reconstructs an image from a viewpoint recommended by the generation apparatus 2 side for each Period while the user is in a fixed position.

A generation method according to Aspect 7 of the present invention is a method for generating data, the method being performed by an apparatus, the method including: a virtual viewpoint image generation step configured to generate a virtual viewpoint image on a per section basis in a virtual space; and a data generation step configured to generate structured data indicating an acquisition source of a piece of data constituting the virtual viewpoint image, in which, in the step of generating the structured data, the structured data is caused to include subset data defining one or more prescribed ranges identifiable from each other, each of the one or more prescribed ranges including one or more virtual viewpoint positions in the virtual space.

A generation method according to Aspect 8 of the present invention is a method for generating data, the method being performed by an apparatus, the method including: a virtual viewpoint image generation step configured to generate a virtual viewpoint image on a per section basis in a virtual space; and a data generation step configured to generate structured data indicating an acquisition source of a piece of data constituting the virtual viewpoint image, in which, in the step of generating the virtual viewpoint image, a virtual viewpoint image is recursively generated from the virtual viewpoint image that has been generated, and in the step of generating the structured data, a data group constituting the virtual viewpoint image of the structured data is caused to include composition level data indicating the number of times of recursive composition through which the virtual viewpoint image is generated.

A generation method according to Aspect 9 of the present invention is a method for generating data, the method being performed by an apparatus, the method including: a virtual viewpoint image generation step configured to generate a virtual viewpoint image on a per section basis in a virtual space; and a data generation step configured to generate structured data indicating an acquisition source of a piece of data constituting the virtual viewpoint image, in which, in the data generation step, the structured data including arrangement pattern data indicating a virtual viewpoint position at which each of a plurality of the virtual viewpoint images is arranged is generated.

A control program for causing a computer to operate as a generation apparatus 2 according to Aspect 10 of the present invention, the control program for causing the computer to operate as the generation apparatus 2 may be a control program configured to cause a computer to operate as the generation apparatus 2 according to any one of Aspects 1 to 3 described above, and may have a configuration to cause the computer to operate as the generation apparatus 2.

A control program for causing a computer to operate as a reconstruction apparatus 20 according to Aspect 11 of the present invention, the control program for causing the computer to operate as the reconstruction apparatus 20 may be a control program configured to cause a computer to operate as the reconstruction apparatus 20 according to any one of Aspects 4 to 6 described above, and may have a configuration to cause the computer to operate as the reconstruction apparatus 20.

A recording medium according to Aspect 12 of the present invention may be a computer-readable recording medium having recorded therein the control program according to Aspect 10.

A recording medium according to Aspect 13 of the present invention may be a computer-readable recording medium having recorded therein the control program according to Aspect 11.

The generation apparatus 2 and the reconstruction apparatus 20 according to each of the aspects of the present invention may be implemented by a computer. In this case, a control program of the generation apparatus 2 and the reconstruction apparatus 20 configured to cause a computer to operate as each unit (software component) included in the generation apparatus 2 and the reconstruction apparatus 20 to implement the generation apparatus 2 and the reconstruction apparatus 20 by the computer and a computer-readable recording medium configured to record the control program are also included in the scope of the present invention.

The present invention is not limited to each of the above-described embodiments. It is possible to make various modifications within the scope of the claims. An embodiment obtained by appropriately combining technical elements each disclosed in different embodiments falls also within the technical scope of the present invention. Further, combining technical elements disclosed in the respective embodiments makes it possible to form a new technical feature.

### REFERENCE SIGNS LIST

1 Image reconstruction system
2 Generation apparatus
3, 21 Controller
4, 22 Storage unit
5, 24 Communication unit
11 Virtual viewpoint image generation unit
12 Data generation unit
13, 35 Communication controller
20 Reconstruction apparatus
23 Display unit
31 Reconstruction processing unit
32 Data acquiring unit
33 Position acquiring unit
34 Display controller

1: A generation apparatus comprising:
a virtual viewpoint image generation circuit configured to generate a virtual viewpoint image on a per section basis in a virtual space; and
a data generation circuit configured to generate structured data indicating an acquisition source of a piece of data constituting the virtual viewpoint image,
wherein the data generation circuit causes
the structured data to include subset data defining one or more prescribed ranges identifiable from each other, each of the one or more prescribed ranges including one or more virtual viewpoint positions in the virtual space.

2-3. (canceled)

4: A reconstruction apparatus comprising:
a data acquiring circuit configured to acquire structured data indicating an acquisition source of a piece of data constituting a virtual viewpoint image generated on a per section basis in a virtual space, the structured data including subset data defining one or more prescribed ranges identifiable from each other, each of the one or more prescribed ranges including one or more virtual viewpoint positions in the virtual space; and
a position acquiring circuit configured to acquire a position of a user in the virtual space,
wherein the data acquiring circuit acquires, with reference to the structured data and the position of the user acquired by the position acquiring circuit, a piece of data constituting the virtual viewpoint image corresponding to a virtual viewpoint position of the one or more virtual viewpoint positions included in a prescribed range of the one or more prescribed ranges in which the user is present.

5-6. (canceled)

7: A method for generating data, the method being performed by an apparatus, the method comprising:
generating a virtual viewpoint image on a per section basis in a virtual space; and
generating structured data indicating an acquisition source of a piece of data constituting the virtual viewpoint image,
wherein, in the step of generating the structured data,
the structured data is caused to include subset data defining one or more prescribed ranges identifiable from each other, each of the one or more prescribed ranges including one or more virtual viewpoint positions in the virtual space.

8-9. (canceled)

10: A control program for causing a computer to operate as the generation apparatus according to claim 1, the control program causing the computer to operate as the generation apparatus.

11: A control program for causing a computer to operate as the reconstruction apparatus according to claim 4, the control program causing the computer to operate as the reconstruction apparatus.

12: A non-transitory computer-readable recording medium having recorded therein the control program according to claim 10.

13: A non-transitory computer-readable recording medium having recorded therein the control program according to claim 11.
